(19) United States
(12) Patent Application Publication
(10) Pub. No.: US 2005/0010895 A1
(43) Pub. Date: Jan. 13, 2005

(54) Software Specification Processing System

(75) Inventor: Parama Jyothi Reddappagari, Tirupati (IN)

Correspondence Address: Parama Jyothi Reddappagari, c/o N Swathi, 40711 Creston Street,, Fremont, 94538, Address encountered without country or state

(73) Assignee: Mr. Parama Jyothi Reddappagari, Tirupati (IN)

(21) Appl. No.: 10/604,290

(22) Filed: Jul. 9, 2003

(51) Int. Cl. G06F 9/44

(52) U.S. Cl. 717/106; 717/141; 717/142

(57) ABSTRACT

This invention is directed towards software development and testing process. The specifications supplied for the development is used and is put along with the program code. Logical functions and Logical predicates can be defined in this framework along with the program code itself to assist in defining specifications. Assertions are inserted along with code statements to describe the state of machine before and after the code statement. The logic engine verifies the assertions for their correctness, hence proving the program code does meet the specifications. The specifications are embedded into the executable or the library whichever is created so that anyone using the library or executable can verify if it is what is needed.

### BACKGROUND OF INVENTION

Current way of developing software is adhoc. The specifications describing the functionality of software is documented in natural language and is kept independent of software being developed except for humans reading the document. Also since the specifications are written in natural language there is scope for misinterpretations.

After reading the specification the programmer develops the program code for the software. During this process the programmer builds the logical state transformation steps in his mind and writes the code for doing that. While the steps of achieving this is present in the program code written, the description of the states itself is lost in the process because of limitations of current programming languages.

After the program code is written, only way to know if it works according to specifications currently is through testing. Inputs are given and outputs are seen to ascertain if they are according to the specifications given. This is costly as well as incomplete step since we can not as certain if program code works for all the cases that may arise unless we test is for eternity.

### SUMMARY OF INVENTION

This invention “Software Specification Processing System” is directed at building a programming system which will make the software more reliable to use and greatly reduce the tedious testing by proving that the program works correctly. The invention is called SpecProc henceforth. It will formally verify if the code written adheres to the specifications with the help of assertions and the logic engine.

The programmer when writes the code, has an understanding of what each statement in the code will do to the state of machine. Unfortunately till now this is only in the programmers mind and at best written as comments in the code. This invention is about being able to express this state information formally in the form of logical statements embedded into the code (“assertions”), which can then be formally verified to see if the written code is according to what is said in assertions. Furthermore the programmer can specify “state transformer assertions”, which can be used to automatically generate code. These can either be just input-output specifications, and/or part code part assertion transformer assertions, which will assist in the generation of program code.

Furthermore the input-output behavior (“specifications”) of the program is currently given as informal specification. With this invention the specifications will be formally written with the code and be used to verify if the codes meets the specifications. Also the specifications will be embedded into the library and executables created so that any program that uses the libraries can know if the code it is importing does meet the requirement.

### BRIEF DESCRIPTION OF DRAWINGS

FIG. 1: This figure shows the flowchart of the SpecProc system.

FIG. 2: This figure shows the flowchart of working of SAAV subsystem within SpecProc system in FIG. 1.

FIG. 3: This figure shows the flowchart of working of assertion validator subsystem, within SAAV subsystem in FIG. 2.

FIG. 4: This figure shows the flowchart of working of STG builder subsystem, within SAAV subsystem in FIG. 2.

FIG. 5: This figure shows the flowchart of working of code function STG builder, within the STG builder subsystem in FIG. 4.

FIG. 6: This figure shows the flowchart of working of logic engine on the STG, within the SpecProc system in FIG. 1.

FIG. 7: This figure shows the flowchart of working of the emitter subsystem, within SpecProc system in FIG. 1.

FIG. 8: This figure shows the STG for the example given.

FIG. 9: This figure shows the STG of the “for” loop.

### DETAILED DESCRIPTION

This invention deals with improvement of software development process. The use of logical specifications is made explicit. First an illustration of the method is given to help understanding and to get a feel of what this is about. Though the syntax used is like C programming language, it should be kept in mind that this is language independent and can be used with any programming language, including object oriented programming languages like C++, Java or C#. In case one does not wish to change the language specifications, one can embed the specifications as special comments as is shown below.

/*{ int Fact(int n)[n>=0]
{ return== *(int i=1,i<=n).i} }*/
int Factorial(int n)
/*[n>=0]*/
{
/*[true]*/
int F=1;
/*[F==Fact(0)]*/
int i=0;
/*[F==Fact(i), i==0]*/
/*[$int j=i;$, j==i]*/
for(i=1/*[i==j+1]*/; i<=n;++i/*[i==j+1]*/)
{
/*[i==j+1, F==Fact(j), i<=n]*/
F*=i;
/*[F==Fact(i)]*/
/*[$j=i;$,j==i, j<=n]*/
}/*[i>n, j<=n, i==j+1, F==Fact(i)]*/
return(F);
}/*[return==Fact(n)]*/

In the listing given between /*{and}*/ the logical function “Fact” is defined. The syntax of “assertion expressions” is that of Boolean expression in C. This is used in the assertions in code function “Factorial” like for example “return==Fact(n)”. In the definition of logical function, we use the mathematical and logical symbols to define. In here “*(int i=1,i<=n).i”, is same as product of i from 1 to n.

Next is the definition of code function “Factorial”. “Assertions statements” are kept between /*[and]*/. Assertion statements contain either “embedded statements” or “assertion expressions” (logical formulas) that hold true at the position they appear in. First assertion “n>=0”, asserts about the input, henceforth referred as input specification. The last assertion “return==Fact(n)”, asserts about the output, henceforth called output assertion.

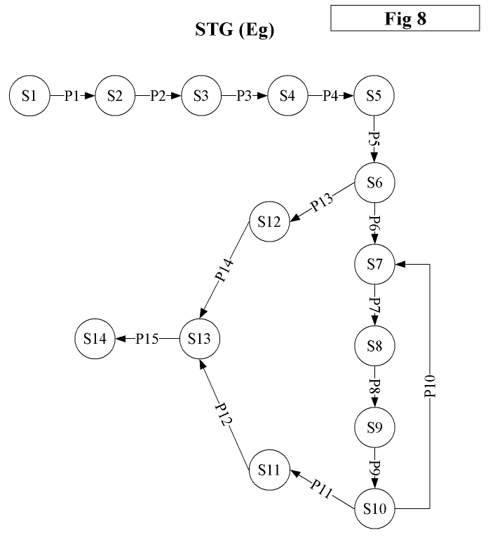

Furthermore assertions statements contains elements enclosed between $, like $int j=i;$ which are referred as embedded statements. These are for keeping track of previous states as they continually change with execution of code statements. The STG for this example is shown in FIG. 8. This has to be read along with the following table.

Description of STG in FIG. 8

| Node/Edge | Content |
|---|---|
| N1 | n>=0 |
| N2 | n>=0 |
| N3 | n>=0, F==Fact(0) |
| N4 | n>=0, F==Fact(i), i==0 |
| N5 | n>=0, F==Fact(i), i==0, j==i |
| N6 | n>=0, F==Fact(j), i==1, j==0 |
| N7 | n>=0, F==Fact(j), i==j+1, i<=n |
| N8 | n>=0, F==Fact(i), i==j+1, i<=n |
| N9 | n>=0, F==Fact(j), i==j, j<=n, i<=n |
| N10 | n>=0, F==Fact(j), i==j+1, j<=n |
| N11 | n>=0, F==Fact(j), i>n, j<=n, i==j+1 |
| N12 | n>=0, F==Fact(j), i>n, i==1, j==0 |
| N13 | n>=0, F==Fact(j), i>n, j<=n, i==j+1 |
| N14 | n>=0, return==Fact(n) |
| P1 | start |
| P2 | int F=1; |
| P3 | int i=0; |
| P4 | $int j=i; |
| P5 | i=1 |
| P6 | if(i<=n) |
| P7 | F*=i; |
| P8 | $j=i; |
| P9 | ++i; |
| P10 | if(i<=n) |
| P11 | if(!(i<=n)) |
| P12 | ; |
| P13 | if(!(i<=n)) |
| P14 | ; |
| P15 | return(F); |

Note that there are many extra assertion expressions in the table, that do not appear is corresponding assertion statements. The way this is done is described in the description of SAAV. The basic idea is that one does not have to write about state of all the variables in assertion statement, but only those that are relevant.

This illustration should have given an overview of what to expect. Further description will start with description of program text's syntactical elements. This is an essential part of SpecProc system. Then the SpecProc system itself is described along with the figures.

Program Text Syntactical Elements: The program consists of two kinds of elements: “Code elements” and “Assertion elements”. The code elements are enriched with assertions. For example in the case of complicated “for” loop:

for( InitStmts /*[InitAsser]*/ ; ForCond ; IncrStmts /*[IncrAsser]*/ )
{
/*[BeginAsser]*/
ForBody
/*[EndAsser]*/
}/*[ForLoopAsser]*/

Note that any of the statements encountered in any programming languages can be enriched in this way. Since for existing languages these are enriched as comments, old compilers can still be used for compilation. In case new language is designed, these assertions can be given syntax of their own. The claims encompass any such addition of assertions, both to existing language and to new languages designed. Also it is to be further noted that runtime assertions (example System.Diagnostics.Debug.Assert in .NET) added to the code is not covered here, but if they are used in proving program functionality, then its subject of this patent.

Assertion elements consists of “Assertion definitions” and “Assertion statements”. Assertion statements are of two types. One being optional embedded statements with set of assertion expressions. Second one being “state transformer assertion”.

Assertion definitions include “Logical predicate definitions” and “Logical function definitions”. These definitions can then be used in assertion statements and further assertion definitions. Logical functions define the function using the logical statements. Logical Predicates define the relation using the logical statements.

Embedded statements in the assertion statements are either “variable declarations” or “assignment statements”. In case variable is declared, these variables are not code variables, but are assertion variables which are available only in assertion statements. The purpose of assertion variables is to store state of either code or assertion variables so that they can be referred later. This is required since the state of machine changes, hence only way to remember the previous state is to assign them to assertion variables. Embedded assignment statements can be used to store state of code variables and/or assertion variables in assertion variables.

Assertion expressions in assertion statement are logical statements formed using code variables and assertion variables. These expressions are expected to be true in the positioned state. Furthermore, these are used by logic engine to establish the proof of working of the program code. Furthermore if required these assertions can be emitted along with the library/executable code so that any user of this can check the working of the code.

State transformer assertions have “from” block and “to” block. “from” block and “to” block both consists of set of assertion expressions. logic engine replaces this state transformation assertion statement with the code and assertions that performs the said transformation, that is it transforms the “from” state to “to” state. Here two examples are given:

Example 1: /*[from[i==j] to[i==j+1]*/

Example 2: /*[from[true] to[Sorted{A}]*/, where “A” is an array, and “Sorted” is predicate that defines an array being sorted.

Input assertion statements (Example: “n>=O”) form the input specifications and the output assertion statements (Example: “return==Fact(n)”) form the output specifications. These will be surely emitted with the code in executable/library so that any other program that refers to this code can know about its input-output behavior.

SpecProc system: The description of SpecProc will be done in parallel with the detailed description of accompanying figures.

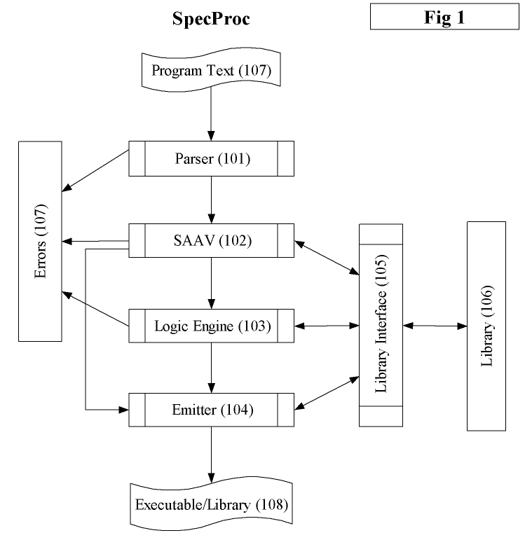

Outline of SpecProc system is shown in FIG. 1. SpecProc consists of following subsystems:
Parser (101)
Semantic Analyzer and Assertion Validator (henceforth referred to as SAAV) (102)
Logic engine (103)
Emitter (104)
Library interface (105)
Library (106)
Errors (107)

When this system is given a program text (108) as input it produces either Executable/Library (109) or gives errors in the program text. The program text has been described previously. Errors (107) is for the purpose of storing the errors that have occurred and later displaying them. Parser (101) takes the input program text and converts it into parse tree. Parser design is well known in computer science [Alfred V. Aho, Ravi Sethi, Jeffrey D. Ullman: Compilers: Principles, Techniques, and Tools. Addison-Wesley 1986].

Library (106) is set of predefined classes and functions. These classes and functions in the Library are enriched with their specifications. This library can either be totally new format or an extension of existing formats. Examples of existing libraries are .NET frameworks, Java class library, C/C++ runtime library etc. Here, a description of how to extend say Java class library is given [Tim Lindholm, Frank Yellin: The Java™ Virtual Machine Specification (2nd Edition), Addison-Wesley Pub Co 1999]. Each “method” in Java class files have attributes. These attributes are extensible in the sense one can add non predefined attributes to it. In the case of SpecProc, specification of the “methods” is added as attributes. The assertion statements can also be added as attributes to the “methods” if specified. Furthermore, the java class file itself contains attributes. This is where the assertion definitions which are associated with this class and the functions in this class can be stored

The library interface (107) provides with way of accessing library. It will be able to locate classes and functions based on names. It will also give the specifications and assertion definitions that are in the library. Furthermore, this will also allow referring to elements of library based on specifications. That is, search based on what requirement specifications are. This is achieved by using indexing based logical formulas and certain keywords such as “sort”, “search” etc.

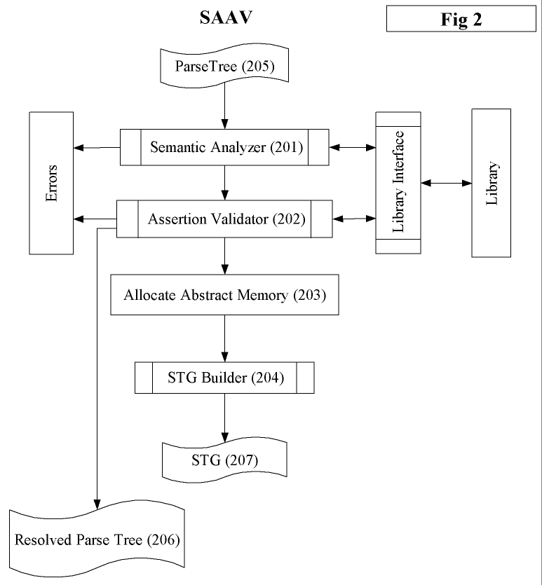

After the parse tree has been generated by the parser and there are no errors in this process, the parse tree is given to SAAV subsystem for analysis. Working of SAAV is shown in FIG. 2. First part of SAAV is semantic analysis (201). This part makes sure that all the classes and types used in the program text are defined. All code functions and code variables used are defined. This uses the library interface for locating the external classes, types and functions that are used. It also performs type checking of all the expressions. Semantic analysis part is well known in computer science [Alfred V. Aho, Ravi Sethi, Jeffrey D. Ullman: Compilers: Principles, Techniques, and Tools. Addison-Wesley 1986]. If there are errors it puts the errors in Errors (107). Along with these checks the parse tree is resolved partially. The process of resolution is adding the external library references to the parse tree. These external library references are then used by logic engine and emitter to properly do their work.

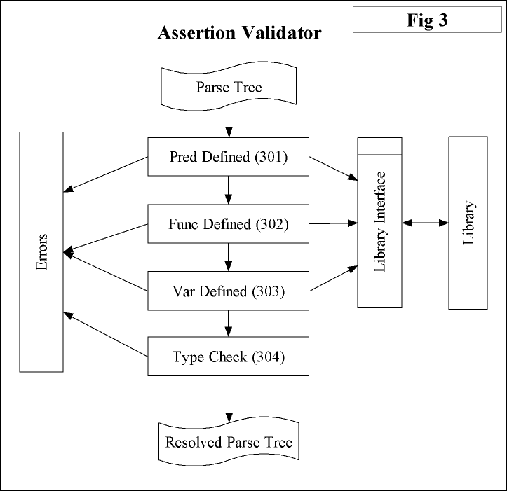

The partially resolved parse tree is then passed to assertion validator (202). Design of assertion validator is shown in FIG. 3. First it checks if all logical predicates used are either part of defined predicates in program text or are present in Library through Library interface (301). If logical predicates are externally resolved it puts that information in parse tree. If some predicates are not found in either program text or in library it gives error. Next it checks for logical functions used (302). These have to be either defined in program text or in library. If these are not defined in either place it will show error. In case the logical function was part of library it will put this information in the parse tree.

Next assertion validator checks if all the variables used in assertion statements (either in embedded statements or in assertion expressions) are either part of code variables (as checked in 201) or part of embedded statement declarations (303). Next The assertion expressions and embedded statements are checked for type validity (304). After this is done, the parse tree is completely resolved, and will be referred as “Resolved parse tree”.

After these checks are made by SAAV, each variable (either code variable or assertion variable) is allocate an abstract memory space to keep track of what is stored in variables and how the content of variables move around (203). Further more for each object instance creation and array creation statements new abstract memory is allocated.

The contents of the variables in abstract memory, is referred as abstract values. These abstract values consist of:
Constant values, like 5, 6.56, ‘c’, “Constant String” etc.
Values in other variables, referred by the variable name, like x, y, i etc.
Any expressions formed by the abstract values, like x+y, A*B where A and B are any abstract values, may be complicated ones in themselves.
Any object instance created using memory allocation (for example “new” in java).
Any array instance created using memory allocation (for example “new [ ]” in java.
Any member dereferencing of object instance expressions, like if A is abstract value of object instance type, and mem is name of member in that object instance type, then A.mem is member dereference expression of corresponding type.
Any indexing of array expressions, like if A is abstract value of type array, and i is abstract value of type int, then A[i] is indexed array expression of corresponding type.

This information is essential for the working of logic engine, for example when some variables is passed by value, new memory is allocated in function call and value of the passed variable is assigned to it, whereas if the parameter is passed by reference, the already allocated memory of the variable is assigned to function parameter, so that the changes to it and its use will be reflected elsewhere as demanded by the semantics of pass by reference.

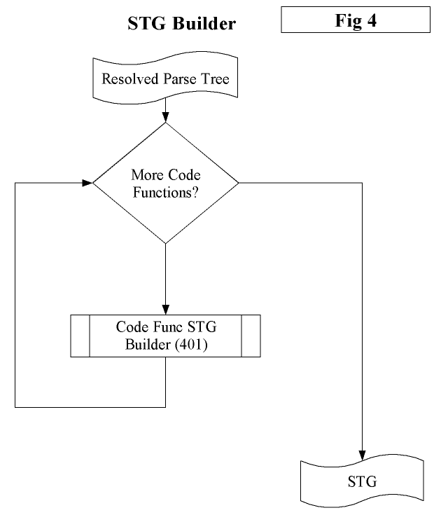

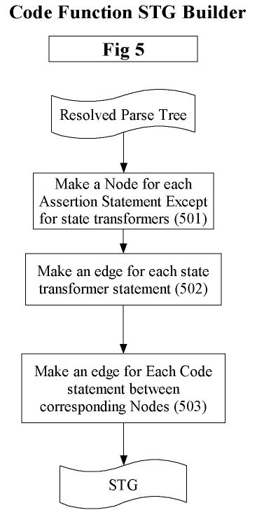

Henceforth, STG stands for “State Transformation Graph”. The resolved parse tree is passed to STG builder (204). The working of STG builder is shown in FIG. 4. For each code function in the resolved parse tree, STG builder builds code function STG using code function STG builder (401). The code function STG builder is shown in FIG. 5.

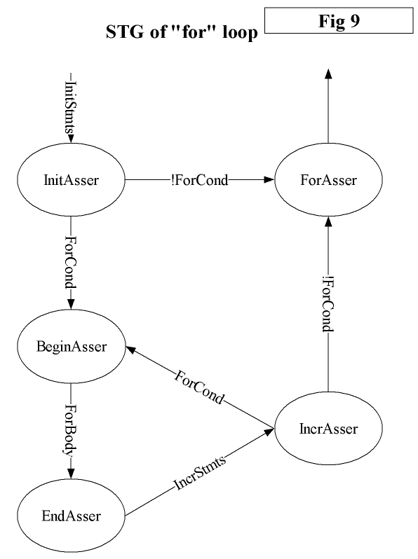

Code function STG builder first builds nodes for each assertion statement that is not state transformer (501). For state transformer assertion statements, it builds two nodes one for “from” expressions and another for “to” expressions in state transformer assertion and an edge between them with a special mark(*) to be used by logic engine (502). For each code statement, it adds an edge between corresponding nodes as source and target (503). The embedded statements are also translated into edges but are flagged($). Partial STG for the “for” loop is shown in FIG. 9. Also look at FIG. 8, and corresponding table above.

The process of building STG also involves analysis of the assertion expressions and code statements. The “frame” of a code statement is defined as all the variables that can change when the said code statement is executed. “View” of the code statement is defined as the the variables that are used by the code statement including variables in embedded statements. Hence, frame is subset of view. The assertion statements for the code statement, will at least describe the frame of the said code statement, using the view. Since the rest of the variables which are not in frame remain unchanged the previous assertion about these still hold. Hence the said previous assertions can also be put in the node of STG for the the currently considered assertion statement.

Whenever an assignment statement is encountered, an abstract value is created for the right hand side. This abstract value and the LValue are stored in the STG. So that logic engine knows what abstract value is being assigned to which LValue. If a function call is seen, then the parameters are passed according to the following rules:
If the parameter is pass by value, new memory is allocated for the parameter and the value in the passed expression is copied to it.
If the parameter is pass by reference, the memory allocated for the passed variable is given to the new variable.

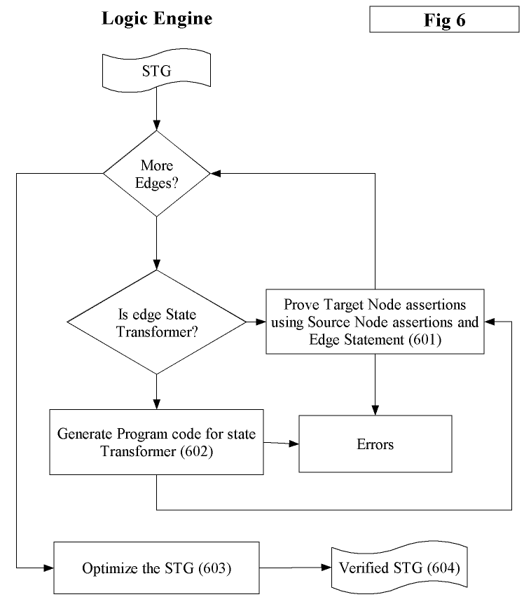

The STG constructed is then passed to logic engine (103). The working of logic engine is shown in FIG. 6. The logic engine is a theorem prover along with proof checker. The designs of theorem prover and proof checkers are part of computer science in Artificial intelligence [R S. Boyer, J S. Moore, A Computational Logic, Academic Press, New York, 1979]. Logic engine will further comprise with abstract evaluator for evaluating the abstract values.

Logic engine takes the STG, and for each edge that is not specially marked (*), it proves that after the code is executed in the state that satisfies the assertions in source node, the assertions is target code will be valid. If this can not be proved it asks users help in proving. (601)

In case the edge is specially marked (*), logic engine will insert appropriate code (In the form of edges and nodes) that satisfies the requirement. It might ask the users help in constructing this appropriate code if need be (602). The STG so constructed and proved is referred as “verified STG”. Illustration of this step for the two examples given above:

Example 1: /*[from[i==j] to[i==j+1]*/, will be converted into STG corresponding to /*[i==j]*/++i;/*[i==j+1]*/

Example 2: /*[from[true] to[Sorted{A}]*/, will be converted to STG corresponding to /*[true]*/Sort(A);/*[Sorted(A)]*/, where “Sort” is code function for sorting array in library.

In either case the users help was sought, SpecProc will store the way of doing the task internally for future purpose, when it encounters similar situation.

Furthermore the logic engine can analyze STG and optimize (603). This optimization step will involve the usage of state information of nodes. For example certain paths might be found to be edges, certain variables being redundant, certain expressions being able to be computed in more optimized ways etc. This information can be used by logic engine to change the verified STG in am optimal way. The ways of optimizing the code is standard in computer science compiler design [Steven S. Muchnick, Advanced Compiler Design and Implementation, Morgan Kaufmann, 1997], but use of STG and logic engine is new.

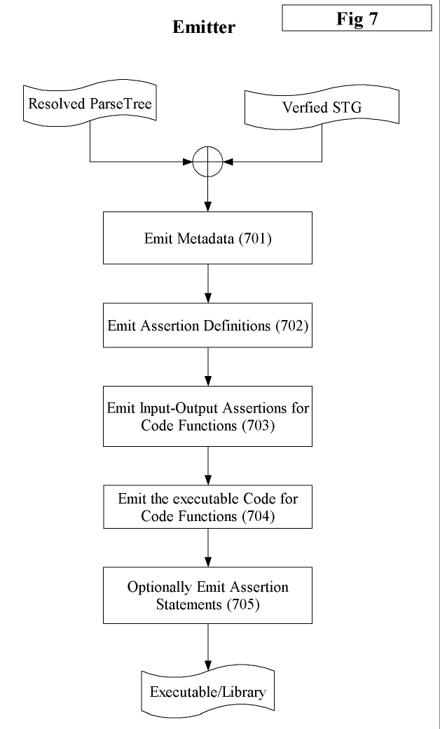

If there were no errors in all the previous steps, then everything is good for emitting the executable/library. The resolved parse tree and verified STG is passed to emitter (104). The working of emitter is shown in FIG. 7. First step is the Emitting of metadata (701). This step involves emitting the class information like class names, external references, class members (fields and methods). This information is obtained from resolved parse tree. Note that only code function signatures are emitted in this step. The next step is emitting assertion definitions (702). Both logical predicates and logical functions are emitted in this step along with their definitions and external references they might have. This is obtained from resolved parse tree.

Next step involves emitting the function specifications for each function (703). This information is emitted from the resolved parse tree. This corresponds to input assertions of the method and the final output assertions of the method. Next two steps (704 & 705), use the Verified STG to emit the code function executable code. For step 704 the edges which are not flagged($) gives the required information. Step 705 is optional and if opted for, the information of verified STG's nodes is emitted in the code functions metadata, corresponding to the executable code instructions. The Step 704 is standard computer science method of emitting code[Alfred V. Aho, Ravi Sethi, Jeffrey D. Ullman: Compilers: Principles, Techniques, and Tools. Addison-Wesley 1986], though the graph in that case in not STG.

While the method and apparatus of SpecProc invention has been described with an exemplary embodiment, many modifications and variations will be apparent to those of ordinary skill in the art. The foregoing description and the following claims are intended to cover all such modifications and variations.

1. A computer-implemented system for generating and verifying the program adhering to given specifications. The said system will henceforth be referred to as SpecProc. The system consists of apparatus for doing the task as well as the method of doing the task.

2. The apparatus of claim 1 consisting of:
The syntactical additions made to the program:
The SpecProc apparatus.

3. The syntactical additions of claim 2 comprising:
Code elements: consisting of usual programming language syntax modified to allow embedding of assertion statements.
Assertion elements: consisting of logical definitions and assertion statements.

4. The said logical definitions of claim 3 further comprising:
Logical function definitions
Logical predicate definitions.

5. The said assertion statements of claim 3 further comprising of:
Embedded code statements.
Set of logical formulas.
State transformer assertions.

6. The SpecProc apparatus of claim 2 further comprising of following subsystems:
A subsystem called library.
A subsystem called parser.
A subsystem called library interface.
A subsystem called semantic analyzer and assertion validator (henceforth referred as SAAV).
A subsystem called logic engine.
A subsystem called emitter.

7. The said library subsystem of claim 6 consisting of:
Store for the code elements as claimed in claim 3 in compiled form including the input-output specifications.
Store for the logical definitions as claimed in claim 4 in complied form.

8. The library subsystem of claim 7, can further optionally store all the assertion statements in the program.

9. The input-output specifications of claim 7, which can either be partial or total.

10. The said library subsystem of claim 7, which can either be an extension of already existing standards or can be totally new format.

11. The said parser subsystem of claim 6, for parsing the program, with the syntax as given in claim 3.

12. The parse tree representation of the program's syntactical additions as claimed in claim 3.

13. The said library interface subsystem of claim 6, consisting of routines for reading the library of claim 7, for resolving the external references in the program.

14. The said library interface subsystem of claim 13, further comprising of ability to search the library of claim 7, based on the input-output specifications of claim 9.

15. The external references of claim 13, consisting of:
Code elements as given in claim 3.
Logical definitions as given in claim 4.

16. The said subsystem SAAV of claim 6, reading the parse tree of claim 12, and doing the following steps:
Resolving the external references using library interface subsystem of claim 13.
Doing the semantic analysis to determine if the parse tree of claim 12 is semantically correct and hence compliable to an executable or to a library of claim 7.

17. State Transformation Graph (henceforth referred as STG) consisting of logical formulas in assertion statements of claim 5 as nodes and code statements as edges, including embedded code statements of claim 5.

18. The STG of claim 17, further consisting of edges for state transformer assertions of claim 5.

19. The abstract values as given in the detailed description and its use in STG of claim 17.

20. The said SAAV of claim 16, further comprising of constructing STG for each code function from the parse tree of claim 12, including the use of embedded code statements of claim 5.

21. The said SAAV of claim 16, further comprising of:
allocating abstract memory for code and assertion variables, and
creating and assigning abstract values of claim 19.

22. The parse tree of claim 12, enriched with external references of claim 15, henceforth referred to as resolved parse tree.

23. The said SAAV as in claim 16, further comprising of:
step of enriching the parse tree of claim 12 to resolved parse tree of claim 22.

24. The said logic engine subsystem of claim 6, reading the STG of claim 17 and doing the following steps:
For each edge proving the target node assertions using the source node assertions and code statement on the edge.
Add edges and nodes to STG of claim 17, in case logic engine encounters state transformer assertions of claim 5.

25. The said logic engine subsystem of claim 24, further comprising of: using the defined logical function definitions and logical predicate definitions of claim 4, in the library of claim 7, through library interface of claim 13, for the proving.

26. The said logic engine subsystem of claim 24, further comprising of: using the abstract values of claim 19, for the proving.

27. The said logic engine subsystem of claim 24, further comprising of: prompting the human user for assistance in proving, if need be.

28. The STG of claim 17 after being processed in logic engine of claim 24, and having new edges in place of state transformer assertions of claim 5, henceforth referred as verified STG.

29. The said logic engine further comprising of: optimization of the verified STG of claim 28.

30. The said emitter subsystem of claim 6, reading the resolved parse tree of claim 22 and verified STG of claim 28 and doing:
Creating either library of claim 7 or executable using resolved parse tree of claim 22 and verified STG of claim 28.
Emitting input-output specifications of claim 9, for code functions.
Emitting logical definitions of claim 4 as part of the emitted library of claim 7 or executable.

31. The said emitter subsystem of claim 30, further consisting of: Emitting the assertion statements including embedded statements of claim 5, optionally depending on users choice.

32. All the said subsystems as in claim 6, further comprising of facility of showing errors.

33. The method of searching the library of claim 7, by the library interface of claim 13, as claimed in claim 14.

34. The method of reading the library subsystem of claim 7, by the library interface subsystem of claim 13, as claimed in claim 13.

35. The method of resolving the logical definitions of claim 4, in library of claim 7, using the library interface of claim 13, as claimed in claim 23.

36. The method of semantic analysis by SAAV of claim 16, of assertion elements of claim 3, using the parse tree of claim 12, as claimed in claim 16.

37. The method of creating abstract values of claim 19, by SAAV of claim 16, as claimed in claim 21.

38. The method of construction of STG of claim 17, by SAAV of claim 16, as given in claim 20.

39. The method of claim 38, further comprising of use of embedded statements of claim 5.

40. The method of enriching parse tree of claim 12, to resolved parse tree of claim 22, as given in claim 23.

41. The method of using STG of claim 17, in logic engine of claim 24, as given in claim 24.

42. The method of using abstract values of claim 19, in logic engine of claim 24, as given in claim 26.

43. The method of adding nodes and edges to STG of claim 17, by the logic engine of claim 24, as given in claim 24.

44. The method of optimizing the verified STG of claim 28, by the logic engine of claim 24, as given in claim 29.

45. The method of emitting input-output specifications of claim 9 of code functions, into executable or library of claim 7, by the emitter of claim 30, as claimed in 30.

46. The method of emitting logical definitions of claim 4, into executable or library of claim 7, by the emitter of claim 30, as claimed in 30.

47. The method of optionally emitting the assertion statements including embedded statements of claim 5, into the executable or library of claim 7, by emitter of claim 30, as claimed in 31.
